(19) United States
(12) Patent Application Publication
(10) Pub. No.: US 2010/0171391 A1
(43) Pub. Date: Jul. 8, 2010

(54) ULTRASONIC MOTOR

(75) Inventor: Tsuyoshi INABA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/683,526

(22) Filed: Jan. 7, 2010

(30) Foreign Application Priority Data
Jan. 8, 2009 (JP) 2009-002938

(51) Int. Cl. H02N 2/12

(52) U.S. Cl. 310/323.02

(57) ABSTRACT

An ultrasonic motor is provided having a first oscillating member and a second oscillating member. The first oscillating member vibrates with a given wavelength. The second oscillating member is separately provided to the first oscillating member, and vibrates with the given wavelength. An annulus is formed by the first oscillating member and the second oscillating member. Part of the first oscillating member overlaps with part of the second oscillating member in a radial direction of the annulus for one quarter of the given wavelength in a circumferential direction of the annulus.

### BACKGROUND OF THE INVENTION

1. Field of the Invention

The invention relates to an ultrasonic motor that is annular and generates turning force from travelling waves created by ultrasonic oscillation, and particularly to the configuration of an oscillating body that creates ultrasonic oscillations.

2. Description of the Related Art

Japanese Patent No. 2694142 discloses an ultrasonic motor comprising an annular piezoelectric body and electrodes provided along its axis. The piezoelectric body has two half-circle segments. The electrodes apply driving voltages with alternating polarity to the piezoelectric body, so that the ultrasonic motor creates a travelling wave.

A piezoelectric body has a length that corresponds to one-half wavelength of the applied high-frequency voltage. A distance between the two half-circle segments is one-quarter wavelength, so as to create a travelling wave that deletes a reflected wave that is generated between the two half-circle segments. A feedback electrode is provided in the distance between the two half-circle segments. The voltage applied to the ultrasonic motor is controlled according to a voltage generated by the feedback electrode.

However, when the applied voltage is controlled by a sensor provided outside of the ultrasonic motor, the feedback electrode is unnecessary. Therefore, the one-quarter wavelength distance between the two half-circle segments is not utilized.

### SUMMARY OF THE INVENTION

An object of the present invention is to provide an ultrasonic motor that efficiently rotates by utilizing an area in which a piezoelectric body is provided.

An ultrasonic motor is provided having a first oscillating member and a second oscillating member. The first oscillating member vibrates with a given wavelength. The second oscillating member is separately provided to the first oscillating member, and vibrates with the given wavelength. An annulus is formed by the first oscillating member and the second oscillating member. Part of the first oscillating member overlaps with part of the second oscillating member in a radial direction of the annulus for one quarter of the given wavelength in a circumferential direction of the annulus.

### BRIEF DESCRIPTION OF THE DRAWINGS

The objects and advantages of the present invention will be better understood from the following description, with reference to the accompanying drawings in which:

FIG. 1 is an exploded perspective view of an ultrasonic motor according to the first embodiment of the present invention;

FIG. 2 is a block diagram of applying electrodes and peripheral circuitry;

FIG. 3 is a plan view of the disposition of the applying electrodes;

FIG. 4 is a plan view of the disposition of the applying electrodes for a comparative example;

FIG. 5 is a graph of the amplitude per each tooth of an elastic member;

FIG. 6 is a plan view of the disposition of the applying electrodes in the second embodiment of the present invention;

FIG. 7 is a graph of the amplitude per each tooth of the elastic member;

FIG. 8 is a plan view of the disposition of the applying electrodes in the third embodiment of the present invention;

FIG. 9 is a graph of the amplitude per each tooth of the elastic member;

FIG. 10 is a plan view of the disposition of the applying electrodes in the fourth embodiment of the present invention;

FIG. 11 is a graph of the amplitude per each tooth of the elastic member in the fourth embodiment of the present invention;

FIG. 12 is a plan view of the disposition of the applying electrodes in the fifth embodiment of the present invention;

FIG. 13 is a plan view of the disposition of the applying electrodes in the sixth embodiment of the present invention; and

FIG. 14 is a plan view of the disposition of the applying electrodes in the seventh embodiment of the present invention

### DESCRIPTION OF THE PREFERRED EMBODIMENTS

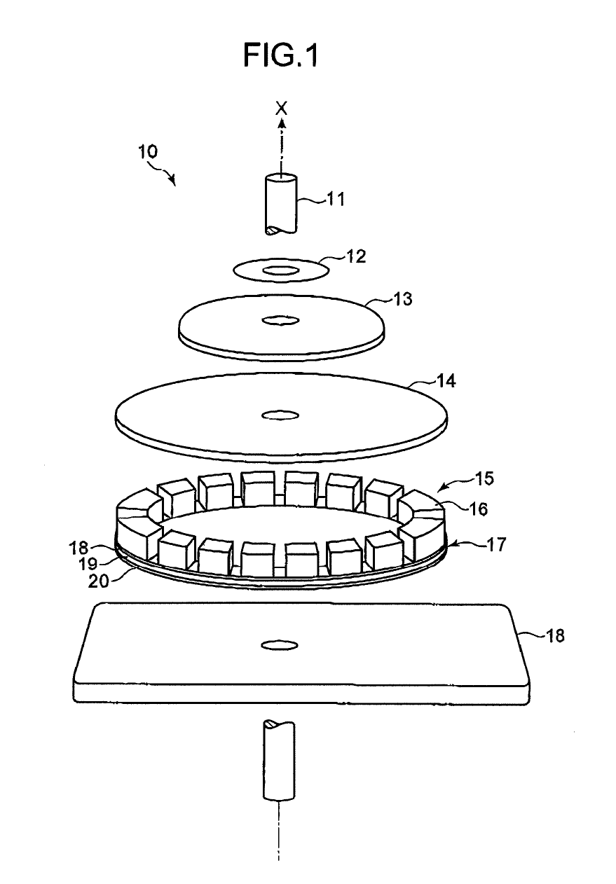

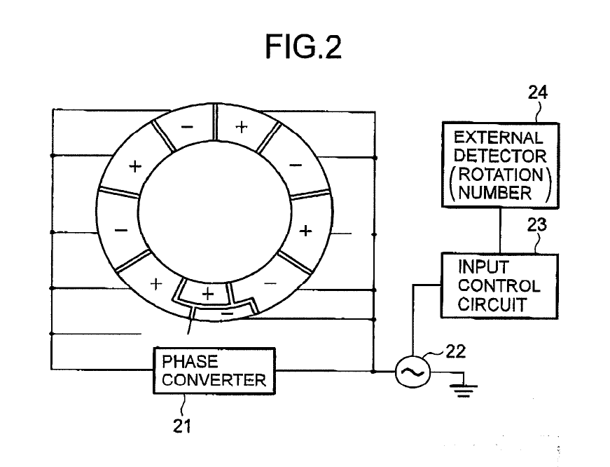

The first embodiment of an ultrasonic motor 10 based on the present invention is described below with reference to FIGS. 1-3.

The ultrasonic motor 10 mainly comprises an output axis 11, an engaging board 12, a spring 13, a rotor 14, a stator 15, and a base 25.

The output axis 11 is positioned on the axis of rotation X of the ultrasonic motor 10, and transmits a turning force generated by the ultrasonic motor 10 to its exterior.

The base 25 is mounted to an external fixed part, and supports the output axis 11 with a bearing (not shown) so that the output axis 11 may rotate freely with respect to the fixed part.

The stator 15 has a discoidal shape and a cylindrical bore that is coaxial with respect to the center axis of the discoid. The diameter of the cylindrical bore is larger than the diameter of the output axis 11, so that the stator 15 does not make contact with the output axis 11. The stator 15 is fixed to the base 25 so that its center axis is coaxial with respect to the axis of rotation X of the ultrasonic motor 10.

The configurations of the engaging board 12, the spring 13, and the rotor 14 are discoidal. Each discoid has a cylindrical bore that is coaxial with respect to the center axis of each one's individual discoidal shape, and their center axes are also coaxial with respect to the axis of rotation X. The engaging board 12 and the spring 13 are both fixed to the output axis 11 that engages with their respective cylindrical bores. The cylindrical bore of the rotor 14 is positioned freely outside of the output axis 11, and is free to move in the radial direction toward and away from the axis of rotation X. Hereinafter, concerning the axis of rotation X, the direction from the base 25 toward the engaging board 12 is described as a positive direction.

The rotor 14 and the spring 13 are resilient along the axis of rotation X. The engaging board 12 presses the rotor 14 and the spring 13 onto the stator 15 by applying a certain amount of pressure. The spring 13 maintains constant pressure that keeps the rotor 14 pressed onto the stator 15.

The stator 15 comprises an elastic member 16, a grounded electrode plate 18, a piezoelectric body 19, and an applying electrode plate 20. The piezoelectric body 19 is provided between the applying electrode plate 20 and the grounded electrode plate 18 along the axis of rotation X. The elastic member 16 is mounted to the front (top) side of the grounded electrode plate 18. The back (lower) side of the grounded electrode plate 18 makes contact with the piezoelectric body 19.

The elastic member 16 is divided into 24 separate teeth at even intervals along its circumference. Each tooth can oscillate individually in the direction parallel to the axis of rotation X. The top of the teeth make contact with the rotor 14.

The piezoelectric body 19 is divided to A regions and B regions. When electrodes are applied to the piezoelectric body 19, the A regions and B regions project in opposite directions, respectively, along the axis of rotation X. That is, in the case that the A regions project in the positive direction along the axis of rotation X, the B regions project in the negative direction along the axis of rotation X. Likewise, in the case that the A regions project in the negative direction along the axis of rotation X, the B regions project in the positive direction along the axis of rotation X. The A regions and the B regions are provided on an alternating basis in the circumferential direction.

The applying electrode plate 20 and the grounded electrode plate 18 are connected to an alternating-current source (an AC source) 22 with a phase converter 21. An exterior detector 24, which is provided outside of the ultrasonic motor 10, detects a number of rotations and sends it to an input control circuit 23. The input control circuit 23 controls the voltage and frequency of the AC source 22 according to the number of rotations. The AC source 22 applies a voltage of 400V at a frequency of 60 kHz to the grounded electrode plate 18 and the applying electrode plate 20.

When an alternating voltage is applied to the applying electrode plate 20, the A regions and the B regions oscillate according to the applied alternating voltage. The elastic member oscillates up and down in the direction of the axis of rotation X, and in a rising and falling waveform that travels along its circumference. The wave generated in the elastic member 16 is called a travelling wave. The rotor 14, which is pushed against the elastic member 16 by the spring 13, rotates with the oscillating elastic member 16. The rotor 14 transmits the turning force from the output axis 11 to the exterior of the ultrasonic motor 10.

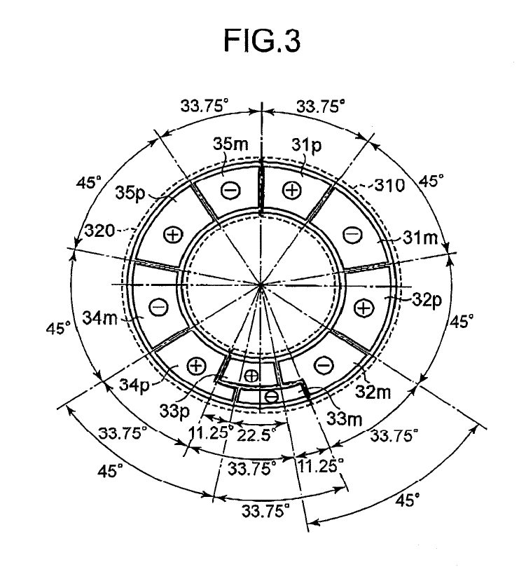

The alignment of the A electrodes and the B electrodes of the applying electrode plate 20 is described below with reference to FIG. 3. FIG. 3 illustrates the applying electrode plate 20 from the perspective of the piezoelectric body 19.

The A regions and the B regions of the piezoelectric body 19 are aligned to face the corresponding A electrodes and B electrodes on the applying electrode plate 20 in all embodiments, therefore, descriptions concerning the alignment of the A regions and the B regions have been omitted. The “+” and “−” markings on the A electrodes and the B electrodes in the figures are for descriptive purposes and do not indicate the polarity of charges applied to the electrodes.

The applying electrode plate 20 comprises first to fifth A electrodes 31p-35p, and first to fifth B electrodes 31m-35m.

The first to third A electrodes 31p-33p, and first and second B electrodes 31m and 32m form a first oscillating member 310. The fourth and fifth A electrodes 34p and 35p, and third to fifth B electrodes 33m-35m form a second oscillating member 320.

Insulators are provided between each electrode to avoid a short circuit. Hereinafter, the size of each electrode is described on the basis of the centerlines of the insulators.

The first A electrode 31p, the first B electrode 31m, the second A electrode 32p, and the second B electrode 32m are aligned in that order on the applying electrode plate 20 in the clockwise direction from the perspective of the engaging board 12. The angular width, i.e. the angular length of the first A electrode 31p in the circumferential direction, expressed as the central angle formed by the endpoints of the electrode at the axis of rotation X, is 33.75°. Similarly, the angular width of each of the first B electrode 31m, the second A electrode 32p, and the second B electrode 32m is 45°. The angular width of the first B electrode 31m, the second A electrode 32p, and the second B electrode 32m are one half of the wavelength of ultrasonic oscillation generated by the elastic member 16.

Similarly, the fifth B electrode 35m is aligned next to the first A electrode 31p in the counter-clockwise direction. The fifth A electrode 35p, the fourth B electrode 34m, and the fourth A electrode 34p are aligned counter-clockwise in that order with the fifth A electrode 35p adjacent to the fifth B electrode 35m in the counter-clockwise direction. The angular width of the fifth B electrode 35m is 33.75° in the circumferential direction. The angular width of each of the fifth A electrode 35p, the fourth B electrode 34m, and the fourth A electrode 34p is 45°. The angular width of the fifth A electrode 35p, the fourth B electrode 34m, and the fourth A electrode 34p are one half of the wavelength of ultrasonic oscillation generated by the elastic member 16.

The third A electrode 33p is provided between the fourth A electrode 34p and the second B electrode 32m. The angular width of the third A electrode 33p is 33.75° in the circumferential direction. Part of the fourth A electrode 34p overlaps with part of the third A electrode 33p in the radial direction on the applying electrode plate 20. The central angle formed by the overlap is 11.25°.

The third B electrode 33m is provided between the fourth A electrode 34p and the second B electrode 32m. The angular width of the third B electrode 33m is 33.75° in the circumferential direction. Part of the second B electrode 32m overlaps with part of the third B electrode 33m in the radial direction on the applying electrode plate 20. The central angle formed by the overlap is 11.25°.

Part of the third A electrode 33p overlaps with part of the third B electrode 33m in the radial direction on the applying electrode plate 20. The central angle formed by the overlap is 22.5°. The angle of overlap corresponds to one quarter of the wavelength of ultrasonic oscillation generated by the elastic member 16. The third A electrode 33p is situated on the interior side of the third B electrode 33m and relatively closer to the axis of rotation X. The borderline separating the third A electrode 33p from the third B electrode 33m in the radial direction is positioned such that the area of the third A electrode 33p is the same as the area of the third B electrode 33m, i.e., the borderline is drawn closer to the outer edge of the applying electrode plate 20 than to the inner edge.

It is assumed that the applying electrode plate is divided equally among eight areas in the circumferential direction and four A electrodes and four B electrodes are aligned alternatingly on the divided area. The angular width of each electrode is 45°. A first oscillating member comprises two A electrodes and two B electrodes which are mutually adjoined and form a round arch. A second oscillating member comprises two A electrodes and two B electrodes which are not included in the first oscillating member. When the alternating voltages are applied to the first oscillating member and the second oscillating member, the A regions and the B regions of the piezoelectric body 19 oscillate. Therefore, the elastic member oscillates up and down in the direction of the axis of rotation X. The oscillation in the elastic member created by the first oscillating member is the stationary wave having four wavelengths. The second oscillating member creates the similar stationary wave in the elastic member. The composite wave made by combining the waves formed by the first and second oscillating member is the stationary wave. The stationary wave created by the oscillation does not travel along the circumference of the elastic member 16, so that the rotor 14 does not rotate against the oscillating elastic member 16. The stationary wave has a wavelength that corresponds to the length calculated by adding the circumferential lengths of the one A electrode and the one B electrode. That is, four wavelengths are provided on the applying electrode plate.

When the angular width of the first to fifth A electrodes 31p-35p and first to fifth B electrodes 31m-35m are described using the wavelength of the stationary wave, the angular width of the first B electrode 31m, the second A electrode 32p, and the second B electrode 32m are one half of the wavelength of the stationary wave. The angular width of the fifth A electrode 35p, the fourth B electrode 34m, and the fourth A electrode 34p are one half of the wavelength of the stationary wave. The angle of overlap between the third A electrode 33p and the third B electrode 33m corresponds to one quarter of the wavelength of the stationary wave.

The oscillation of the elastic member 16 by the first oscillating member is out of phase with the oscillation of the elastic member 16 by the second oscillating member. This phase shift creates a traveling wave on the elastic member 16. The wavelength of the stationary wave is substantially the same as the wavelength of the travelling wave.

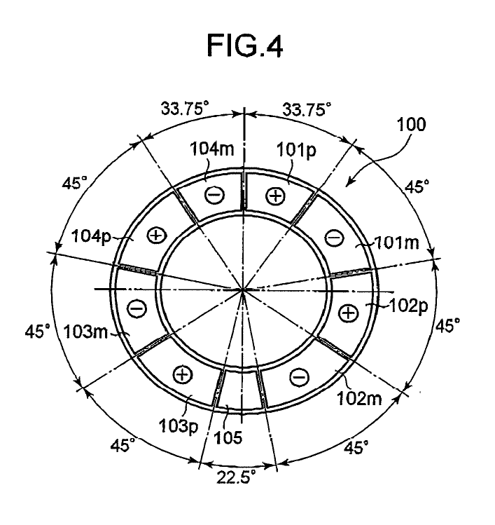

A comparative applying electrode plate 100 provided in an ultrasonic motor is described below with reference to FIG. 4. FIG. 4 illustrates the applying electrode plate 100 from the perspective of the piezoelectric body. The similar constructions in the inventions are similarly numbered, and the descriptions for such constructions have been omitted.

The applying electrode plate 100 comprises first to fourth A electrodes 101p-104p, first to fourth B electrodes 101m-104m, and a feedback electrode 105. Insulators are provided between each electrode to avoid short circuits.

The first A electrode 101p, the first B electrode 101m, the second A electrode 102p, and the second B electrode 102m are aligned in that order on the applying electrode plate 100 in the clockwise direction from the perspective of the engaging board 12. The angular width, i.e. the angular length of the first A electrode 101p in the circumferential direction, expressed as the central angle formed by the endpoints of the electrode at the axis of rotation X, is 33.75°. Similarly, the angular width of each of the first B electrode 101m, the second A electrode 102p, and the second B electrode 102m is 45°.

Similarly, the fourth B electrode 104m is aligned next to the first A electrode 101p in the counter-clockwise direction. The fourth A electrode 104p, the third B electrode 103m, and the third A electrode, 103p are aligned counter-clockwise in that order with the fourth A electrode 104p adjacent to the fourth B electrode 104m in the counter-clockwise direction. The angular width of the fourth B electrode 104m is 33.75° in the circumferential direction. The angular width of each of the fourth A electrode 104p, the third B electrode 103m, and the third A electrode 103p is 45°.

The feedback electrode 105 is provided between the third A electrode 103p and the second B electrode 102m. The angular width of the feedback electrode 105 is 22.5° in the circumferential direction.

Each one of the A and B electrodes is connected to the AC source 22 with the phase converter 21. The feedback electrode 105 detects the number of rotations of the piezoelectric body 19, and sends it to the input control circuit 23. The comparative ultrasonic motor does not have the exterior detector 24. The input control circuit 23 controls the voltage and frequency of the AC source 22 according to the number of oscillations of the piezoelectric body sent by the feedback electrode 105. The applied AC voltage is 400V, and the frequency is 60 kHz.

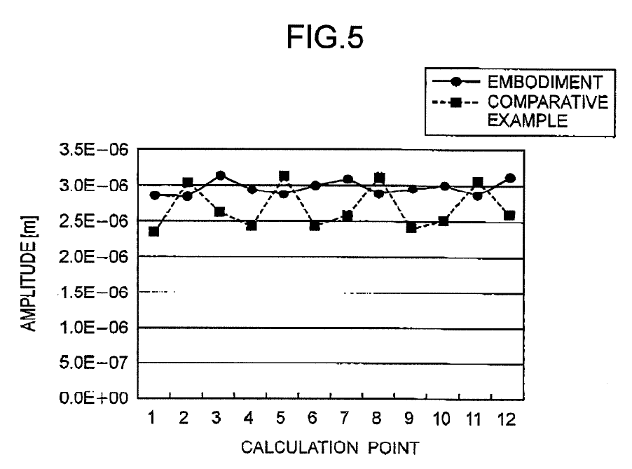

A computational simulation result of the ultrasonic motor 10 according to the first embodiment is described below with reference to FIG. 5. FIG. 5 is a graph showing the computational result of the amplitude per tooth of the elastic member 16 according to the first embodiment and the comparative example.

The amplitudes are calculated on the basis of a calculating point located at the top of each tooth. There are 12 teeth in total, and the top of each tooth makes contact with the rotor 14. The 12 calculating points are provided at intervals of one per tooth.

The standard deviation of the amplitude of the comparative example is 2.813e-7 meter; on the other hand, the standard deviation of the amplitude of the invention is 1.29e-7 meter. The comparative example has a larger variation between the amplitudes of the teeth, which prevents the ultrasonic motor 10 from generating stable rotating power. However, the third embodiment has a relatively smaller variation between the amplitude of each tooth; therefore, the ultrasonic motor 10 can generate rotating power with relatively greater stability.

The mean of the amplitudes of the comparative example is 2.74e-6 meter; on the other hand, the mean of the amplitudes of the invention is 3.02e-6 meter. Relatively larger amplitudes are created by the third embodiment than by the comparative example.

The first embodiment can eliminate the influence of reflected waves and provide an ultrasonic motor 10 that rotates efficiently.

Note that the borderline separating the third A electrode 33p from the third B electrode 33m may be a centerline of the applying electrode plate 20 in the radial direction.

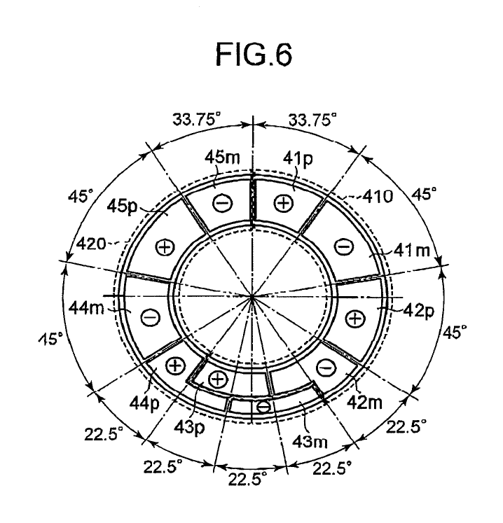

The second embodiment of an ultrasonic motor 10 is described below with reference to FIG. 6. FIG. 6 illustrates the applying electrode plate 20 as seen from the piezoelectric body 19. The constructions similar to the first embodiment are numbered similarly, and descriptions concerning such constructions have been omitted.

The applying electrode plate 20 comprises twenty-first to twenty-fifth A electrodes 41p-45p, and twenty-first to twenty-fifth B electrodes 41m-45m.

The twenty-first to twenty-third A electrodes 41p-43p, and twenty-first and twenty-second B electrodes 41m and 42m form a first oscillating member 410. The twenty-fourth and twenty-fifth A electrodes 44p and 45p, and twenty-third to twenty-fifth B electrodes 43m-45m form a second oscillating member 420.

The twenty-first A electrode 41p, the twenty-first B electrode 41m, the twenty-second A electrode 42p, and the twenty-second B electrode 42m are aligned in that order on the applying electrode plate 20 in the clockwise direction from the perspective of the engaging board 12. The angular width, i.e. the angular length of the twenty-first A electrode 41p in the circumferential direction, expressed as the central angle formed by the endpoints of the electrode at the axis of rotation X, is 33.75°. Similarly, the angular width of the twenty-first B electrode 41m, the twenty-second A electrode 42p, and the twenty-second B electrode 42m is 45°. The angular width of the twenty-first B electrode 41m, the twenty-second A electrode 42p, and the twenty-second B electrode 42m are one half of the wavelength of ultrasonic oscillation generated by the elastic member 16. In other words, the angular width of the twenty-first B electrode 41m, the twenty-second A electrode 42p, and the twenty-second B electrode 42m are one half of the wavelength of the stationary wave, which is described hereinbefore.

Similarly, the twenty-fifth B electrode 45m is aligned next to the twenty-first A electrode 41p in the counter-clockwise direction. The twenty-fifth A electrode 45p, the twenty-fourth B electrode 44m, and the twenty-fourth A electrode 44p are aligned next to the twenty-fifth B electrode 45m in that order in the counter-clockwise direction, with the twenty-fifth A electrode 45p adjacent to the twenty-fifth B electrode 45m. The angular width of the twenty-fifth B electrode 45m is 33.75° in the circumferential direction. The angular width of each of the twenty-fifth A electrode 45p, the twenty-fourth B electrode 44m, and the twenty-fourth A electrode 44p is 45°. The angular width of the twenty-fifth A electrode 45p, the twenty-fourth B electrode 44m, and the twenty-fourth A electrode 44p are one half of the wavelength of ultrasonic oscillation generated by the elastic member 16. In other words, the angular width of the twenty-fifth A electrode 45p, the twenty-fourth B electrode 44m, and the twenty-fourth A electrode 44p are one half of the wavelength of the stationary wave.

The twenty-third A electrode 43p is provided between the twenty-fourth A electrode 44p and the twenty-second B electrode 42m. The angular width of the twenty-third A electrode 43p is 45° in the circumferential direction. Part of the twenty-fourth A electrode 44p overlaps with part of the twenty-second A electrode 43p in the radial direction on the applying electrode plate 20. The central angle formed by the overlap is 22.5°.

The twenty-third B electrode 43m is provided between the twenty-fourth A electrode 44p and the twenty-second B electrode 42m. The angular width of the twenty-third B electrode 43m is 45° in the circumferential direction. Part of the twenty-second B electrode 42m overlaps with part of the twenty-third B electrode 43m in the radial direction on the applying electrode plate 20. The central angle formed by the overlap in 22.5°.

Part of the twenty-third A electrode 43p overlaps with part of the twenty-third B electrode 43m in the radial direction on the applying electrode plate 20. The central angle formed by the overlap is 22.5°. The angle of overlap corresponds to one quarter of the wavelength of ultrasonic oscillation generated by the elastic member 16. In other words, the angle of overlap between the twenty-third A electrode 43p and the twenty-third B electrode 43m corresponds to one quarter of the wavelength of the stationary wave.

The twenty-third A electrode 43p is situated on the interior side of the twenty-third B electrode 43m and relatively closer to the axis of rotation X. The borderline separating the twenty-third A electrode 43p from the twenty-third B electrode 43m in the radial direction is positioned such that the area of the twenty-third A electrode 43p is equal to the area of the twenty-third B electrode 43m, i.e., the borderline is drawn closer to the outer edge of the applying electrode plate 20 than to the inner edge.

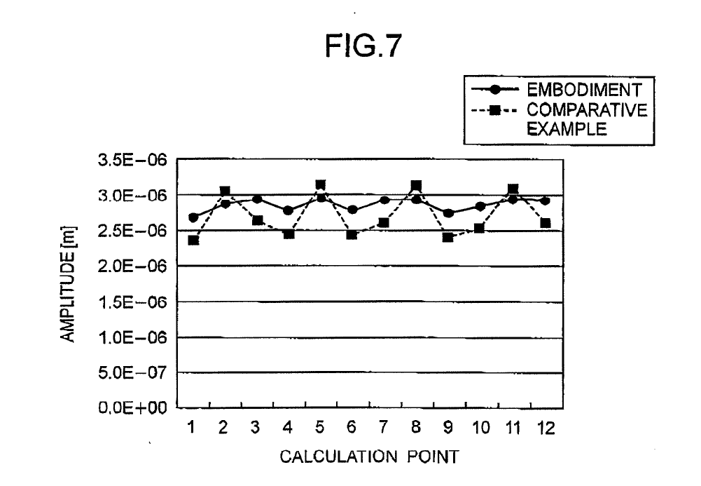

A computational simulation result of the ultrasonic motor 10 according to the second embodiment is described below with reference to FIG. 7. FIG. 7 is a graph showing the computational result of the amplitude per tooth of the elastic member 16 according to the second embodiment and the comparative example described hereinbefore.

The standard deviation of the amplitudes of the comparative example is 2.88e-7 meter; on the other hand, the standard deviation of the amplitudes of the invention is 1.11e-7 meter. The comparative example has greater variation in the amplitudes of the teeth, which prevents the ultrasonic motor 10 from generating stable rotating power. However, the third embodiment has a relatively smaller variation between the amplitude of each tooth; therefore, the ultrasonic motor 10 can generate rotating power with relatively greater stability.

The mean of the amplitudes of the comparative example is 2.74e-6 meter; on the other hand, the mean of the amplitudes of the invention is 2.90e-6 meter. According to the third embodiment, relatively larger amplitudes are created than in the comparative example.

Note that the borderline separating the twenty-third A electrode 43p from the twenty-third B electrode 43m may be a centerline of the applying electrode plate 20 in the radial direction.

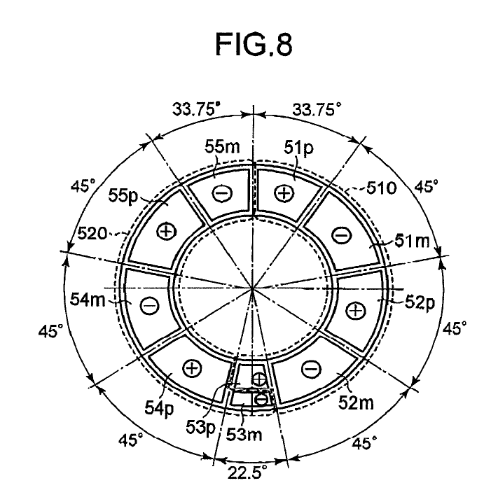

The third embodiment of an ultrasonic motor 10 is described below with reference to FIG. 8. The constructions similar to the first and second embodiments are similarly numbered, and the descriptions concerning such constructions have been omitted.

The applying electrode plate 20 comprises thirty-first to thirty-fifth A electrodes 51p-55p, and thirty-first to thirty-fifth B electrodes 51m-55m.

The thirty-first to thirty-third A electrodes 51p-53p, and thirty-first and thirty-second B electrodes 51m and 52m form a first oscillating member 510.

The thirty-fourth and thirty-fifth A electrodes 54p and 55p, and thirty-third to thirty-fifth B electrodes 53m-55m form a second oscillating member 520.

The thirty-first A electrode 51p, the thirty-first B electrode 51m, the thirty-second A electrode 52p, and the thirty-second B electrode 52m are aligned in that order on the applying electrode plate 20 in the clockwise direction from the perspective of the engaging board 12. The angular width, i.e. the length of the thirty-first A electrode 51p in the circumferential direction, expressed as the central angle formed by the endpoints of the electrode at the axis of rotation X, is 33.75°. Similarly, the angular width of each of the thirty-first B electrode 51m, the thirty-second A electrode 52p, and the thirty-second B electrode 52m is 45°. The angular widths of the thirty-first B electrode 51m, the thirty-second A electrode 52p, and the thirty-second B electrode 52m are one half of the wavelength of ultrasonic oscillation generated by the elastic member 16. In other words, the angular widths of the thirty-first B electrode 51m, the thirty-second A electrode 52p, and the thirty-second B electrode 52m are one half of the wavelength of the stationary wave, which is described hereinbefore.

Similarly, the thirty-fifth B electrode 55m is aligned next to the thirty-first A electrode 51p in the counter-clockwise direction. The thirty-fifth A electrode 55p, the thirty-fourth B electrode 54m, and the thirty-fourth A electrode 54p are aligned next to the thirty-fifth B electrode 55m in that order on the applying electrode plate 20 in the counter-clockwise direction from the perspective of the engaging board 12. The angular width of the thirty-fifth B electrode 55m is 33.75° in the circumferential direction. The angular width of each of the thirty-fifth A electrode 55p, the thirty-fourth B electrode 54m, and the thirty-fourth A electrode 54p is 45°. The widths of the thirty-fifth A electrode 55p, the thirty-fourth B electrode 54m, and the thirty-fourth A electrode 54p are one half of the wavelength of ultrasonic oscillation generated by the elastic member 16. In other words, the widths of the thirty-fifth A electrode 55p, the thirty-fourth B electrode 54m, and the thirty-fourth A electrode 54p are one half of the wavelength of the stationary wave.

The thirty-third A electrode 53p and the thirty-third B electrode 53m are provided between the thirty-fourth A electrode 54p and the thirty-second B electrode 52m. The angular width of each of the thirty-third A electrode 53p and the thirty-third B electrode 53m is 22.5° in the circumferential direction. The thirty-third A electrode 53p completely overlaps the thirty-third B electrode 53m in the radial direction on the applying electrode plate 20. The angle of overlap is equal to the angular length of the thirty-third A electrode 53p and the thirty-third B electrode 53m, which is 22.5° in the circumferential direction. The angle of overlap corresponds to one quarter of the wavelength of ultrasonic oscillation generated by the elastic member 16. In other words, the angle of overlap between the thirty-third A electrode 53p and the thirty-third B electrode 53m corresponds to one quarter of the wavelength of the stationary wave.

The thirty-third A electrode 53p is situated on the interior side of the thirty-third B electrode 53m and relatively closer to the axis of rotation X. The borderline separating the thirty-third A electrode 53p from the thirty-third B electrode 53m in the radial direction is positioned such that the area of the thirty-third A electrode 53p is equal to the area of the thirty-third B electrode 53m, i.e., the borderline is drawn closer to the outer side of the applying electrode plate 20 relative to the centerline.

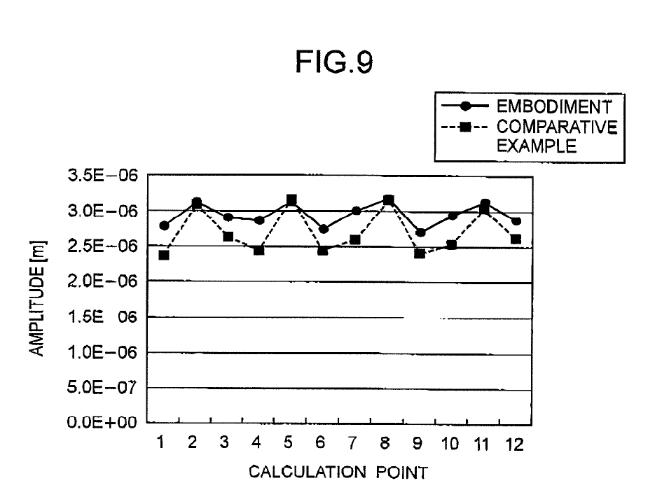

A computational simulation result of the ultrasonic motor 10 according to the first embodiment is described below with reference to FIG. 9. FIG. 9 is a graph showing the computational result of the amplitude per tooth of the elastic member 16 according to the third embodiment and the comparative example described hereinbefore.

The standard deviation of the amplitudes of the comparative example is 2.88e-7 meter; on the other hand, the standard deviation of the amplitudes of the invention is 1.66e-7 meter. The comparative example has greater variation in the amplitudes of the teeth, which prevents the ultrasonic motor 10 from generating stable rotating power. However, the third embodiment has a relatively smaller difference between the amplitude of each tooth; therefore, the ultrasonic motor 10 can create generate rotating power with relatively greater stability.

The mean of the amplitude of the comparative example is 2.74e-6 meter; on the other hand, the mean of the amplitude of the invention is 2.99e-6 meter. According to the third embodiment, relatively larger amplitudes are created than in the comparative example.

Note that, the borderline separating the thirty-third A electrode 53p from the thirty-third B electrode 53m may be a centerline of the applying electrode plate 20 in the radial direction.

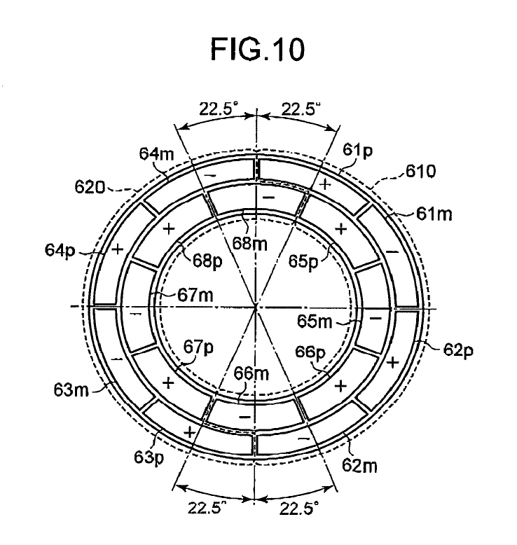

The fourth embodiment of an ultrasonic motor 10 is described below with reference to FIG. 10. The constructions similar to the first to third embodiments are numbered similarly, and the descriptions concerning such constructions have been omitted.

The applying electrode plate 20 comprises forty-first to forty-eighth A electrodes 41p-48p, and forty-first to forty-eighth B electrodes 61m-68m.

The forty-first, forty-second, forty-fifth, and forty-sixth A electrodes 61p, 62p, 65p, and 66p, and the forty-first, forty-second, forty-fifth, and forty-sixth B electrodes 61m, 62m, 65m, and 66m form a first oscillating member 610.

The forty-third, forty-fourth, forty-seventh, and forty-eighth A electrodes 63p, 64p, 67p, and 68p, and the forty-third, forty-fourth, forty-seventh, and forty-eighth B electrodes 63m, 64m, 67m, and 68m form a second oscillating member 620.

The forty-first to forty fourth A electrodes 61p-64p and forty-first to forty-fourth B electrodes 61m-64m are provided on the outer side of the applying electrode plate 20 and relatively further away from the axis of rotation X. The forty-fifth to forty-eighth A electrodes 65p-68p, and forty-fifth to forty-eighth B electrodes 65m-68m are provided on the inner side and relatively closer to the axis of rotation X. The angular width, i.e. the length of each electrode in the circumferential direction, expressed as the central angle formed by the endpoints of the electrode at the axis of rotation X, is 45°. Their angular widths correspond to one half of the wavelength of ultrasonic oscillation generated by the elastic member 16. In other words, the angular width of the forty-first to forty-fourth A electrodes 61p-64p, forty-first to forty-fourth B electrodes 61m-64m, the forty-fifth to forty-eighth A electrodes 65p-68p, and forty-fifth to forty-eighth B electrodes 65m-68m are 45°, i.e. one half of the wavelength of the stationary wave, which is described hereinbefore.

The forty-first A electrode 61p, the forty-first B electrode 61m, the forty-second A electrode 62p, the forty-second B electrode 62m, the forty-third A electrode 63p, the forty-third B electrode 63m, the forty-fourth A electrode 64p, and the forty-fourth B electrode 64m are aligned on the outer side of the applying electrode plate 20 in the clockwise direction from the perspective of the engaging board 12.

The forty-fifth A electrode 65p, the forty-fifth B electrode 65m, the forty-sixth A electrode 66p, the forty-sixth B electrode 66m, the forty-seventh A electrode 67p, the forty-seventh B electrode 67m, the forty-eighth A electrode 68p, and the forty-eighth B electrode 68m are aligned on the inner side of the applying electrode plate 20 in the clockwise direction from the perspective of the engaging board 12.

From the perspective of the axis of rotation X, the forty-fifth A electrode 65p is positioned on the inner side of the forty-fourth B electrode 64m and the forty-first A electrode 61p in the radial direction, and overlaps each one of them by a circumferential angle of 22.5°. The radial centerlines separating the outer electrodes are shifted 22.5° from the radial centerlines separating the inner electrodes. The shifted angle corresponds to one quarter of the wavelength of the stationary wave.

The circumferential borderline between the outer electrodes and the inner electrodes is positioned such that the area of each outer electrode is equal to the area of each inner electrode, i.e., in the radial direction the borderline is situated closer to the outer edge than the inner edge of the applying electrode plate 20.

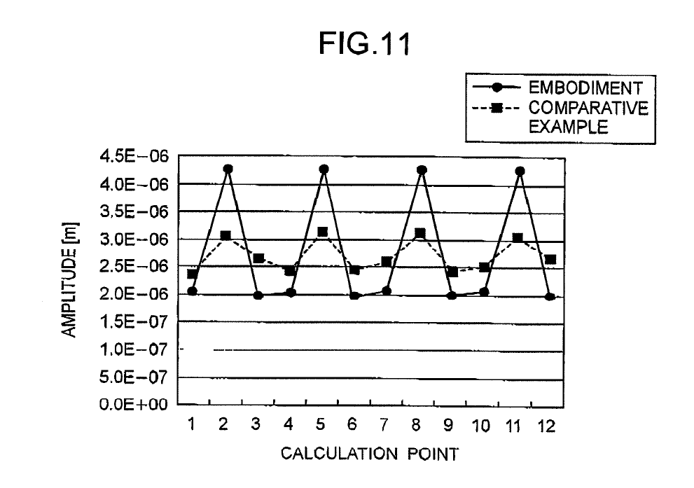

A computational simulation result of the ultrasonic motor 10 according to the first embodiment is described below with reference to FIG. 11. FIG. 11 is a graph showing the computational result of the amplitude per tooth of the elastic member 16 according to the fourth embodiment and the comparative example described hereinbefore.

The standard deviation of the amplitudes of the comparative example is 2.88e-7 meter; on the other hand, the standard deviation of the amplitudes of the invention is 1.11e-6 meter. The mean of the amplitudes of the comparative example is 2.74e-6 meter; on the other hand, the mean of the amplitudes of the invention is 2.81e-6 meter. The third embodiment produces larger amplitudes than the comparative example.

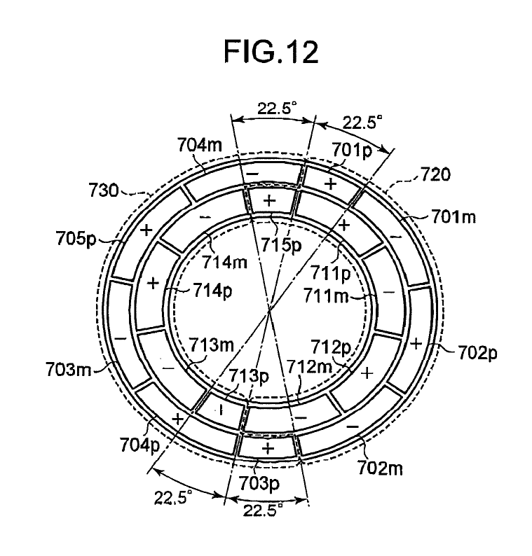

The fifth embodiment of an ultrasonic motor 10 is described below with reference to FIG. 12. The constructions similar to the first to fourth embodiments are numbered similarly, and descriptions concerning such constructions have been omitted.

The applying electrodes 20 comprises fifty-first to fifty-fifth A electrodes 701p-705p, fifty-sixth to sixtieth A electrodes 711p-712p, fifty-first to forty-fourth B electrodes 701m-704m, and fifty-fifth to forty-eighth B electrodes 711m-714m.

The fifty-first and fifty-second A electrodes 701p and 702p, fifty-first and fifty-second B electrodes 701m and 702m, fifty-sixth, fifty-seventh, and sixtieth A electrodes 711p, 712p and 715p, and fifty-fifth and fifty-sixth B electrodes 711m and 712m form a first oscillating member 720.

The fifty-third to fifty-fifth A electrodes 703p-705p, fifty-third and fifty-fourth B electrodes 703m and 704m, fifty-eighth and fifty-ninth A electrodes 713p and 714p, and fifty-seventh and fifty-eighth B electrodes 713m and 714m form a second oscillating member 730.

The fifty-first to fifty-fifth A electrodes 701p-705p and the fifty-first to fifty-fourth B electrodes 701m-704m form an exterior electrode and are provided on the outermost side of the applying electrode plate 20. The fifty-sixth to sixtieth A electrodes 711p-715p and fifty-fifth to forty-eighth B electrodes 711m-714m form an interior electrode and are provided on the innermost side of the applying electrode plate 20.

From the perspective of the engaging board 12, the fifty-first A electrode 701p, fifty-first B electrode 701m, fifty-second A electrode 702p, the fifty-second B electrode 702m, fifty-third A electrode 703p, fifty-fourth A electrode 704p, fifty-third B electrode 703m, fifty-fifth A electrode 705p, and fifty-fourth B electrode 704m are aligned clockwise in that order along the outer side of the applying electrode plate 20.

From the perspective of the engaging board 12, the fifty-sixth A electrode 711p, fifty-fifth B electrode 711m, fifty-seventh A electrode 712p, fifty-sixth B electrode 712m, fifty-eighth A electrode 713p, fifty-seventh B electrode 713m, fifty-ninth A electrode 714p, fifty-eighth B electrode 714m, and sixtieth A electrode 715p are aligned clockwise in that order along the inner side of the applying plate 20.

The angular width, i.e. the length of the fifty-first A electrode 701p, the fifty-third A electrode 703p, the fifty-eighth A electrode 713p, and the sixtieth A electrode 715p in the circumferential direction, expressed as a central angle formed by the endpoints of each electrode at the axis of rotation X, is 22.5°. The angular width corresponds to one quarter of the wavelength of ultrasonic oscillation generated by the elastic member 16. In other words, the angular widths of the fifty-first A electrode 701p, the fifty-third A electrode 703p, the fifty-eighth A electrode 713p, and the sixtieth A electrode 715p are one quarter of the wavelength of the stationary wave, which is described hereinbefore. The angular width of the each of the other A and B electrodes is 45°. The angular width corresponds to one half of the wavelength of ultrasonic oscillation generated by the elastic member 16. In other words, the angular width of each of the other A and B electrodes is one half of the wavelength of the stationary wave.

From the perspective of the axis of rotation X in the radial direction, the fifty-first A electrode 701p overlaps with the fifty-sixth A electrode 711p, the fifty-third A electrode 703p overlaps with the fifty sixth B electrode 712m, the fifty-eighth A electrode 713p overlaps with the fifty-fourth A electrode 704p, and the sixtieth A electrode 715p overlaps with the fifty-fourth B electrode 704m.

Also from the perspective of the axis of rotation X, the A and B electrodes of the outer electrode overlap with the A and B electrodes of the inner electrode by 22.5° in the circumferential direction. The radial centerlines between the outer electrodes are shifted 22.5° from the radial centerlines between the inner electrodes. The shifted angle corresponds to one quarter of the wavelength of the stationary wave. Note that the radial centerline between the fifty-sixth A electrode 711p and the sixtieth A electrode 715p corresponds to the borderline between the fifty-first A electrode 701p and the fifty-fourth B electrode 704m in the radial direction. Likewise, the radial centerline between the fifty-sixth B electrode 712m and the fifty-eighth A electrode 713p corresponds to the radial centerline between the fifty-third A electrode 703p and the fifty-fourth A electrode 704p in the radial direction.

The borderline separating the exterior electrode from the interior electrode bisects the applying electrode plate 20 in the radial direction.

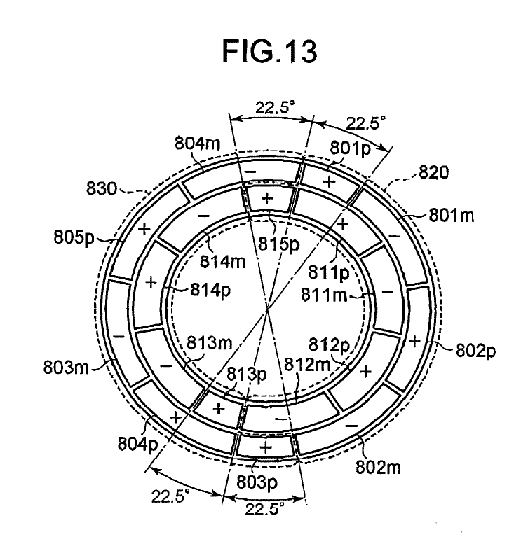

The sixth embodiment of an ultrasonic motor 10 is described below with reference to FIG. 13. The similar constructions to the first to fifth embodiments are numbered similarly, and the descriptions concerning such constructions have been omitted.

The applying electrode plate 20 comprises sixty-first to sixty-fifth A electrodes 801p-805p, sixty-sixth to seventieth A electrodes 811p-815p, sixty-first to sixty-fourth B electrodes 801m-804m, and sixty-fifth to sixty-eighth B electrodes 811m-814m.

The sixty-first and sixty-second A electrodes 801p and 802p, sixty-first and sixty-second B electrodes 801m and 802m, sixty-sixth, sixty-seventh, and seventieth A electrodes 811p, 812p, and 815p, and sixty-fifth and sixty-sixth B electrodes 811m and 812m form a first oscillating member 820.

The sixty-third, sixty-fourth, and sixty-fifth A electrodes 803p, 804p, and 805p, sixty-third and sixty-fourth B electrodes 803m and 804m, sixty-eighth and sixty-ninth A electrodes 813p and 814p, and sixty-seventh and sixty-eighth B electrodes 813m and 814m form a second oscillating member 830.

The sixty-first to sixty-fifth A electrodes 801p-805p and the sixty-first to sixty-fourth B electrodes 801m-804m form an exterior electrode that is provided on the outermost side of the applying electrode plate 20. The sixty-sixth to seventieth A electrodes 811p-815p and sixty-fifth to sixty-eighth B electrodes 811m-814m form an interior electrode that is provided on the innermost side of the applying electrode plate 20.

From the perspective of the engaging board 12, the sixty-first A electrode 801p, the sixty-first B electrode 801m, the sixty-second A electrode 802p, the sixty-second B electrode 802m, the sixty-third A electrode 803p, the sixty-fourth A electrode 804p, the sixty-third B electrode 803m, the sixty-fifth A electrode 805p, and the sixty-fourth B electrode 804m are aligned in that order on the applying electrode plate 20 in the clockwise direction.

From the perspective of the engaging board 12, the sixty-sixth A electrode 811p, the sixty-fifth B electrode 811m, the sixty-seventh A electrode 812p, the sixty-sixth B electrode 812m, the sixty-eighth A electrode 813p, the sixty-seventh B electrode 813m, the sixty-ninth A electrode 814p, the sixty eighth B electrode 814m, and the seventieth A electrode 815p are aligned in that order on the applying electrode plate 20 in the clockwise direction.

The angular width, i.e. the length of each of the sixty-first A electrode 801p, the sixty-third A electrode 803p, the sixty-eighth A electrode 813p, and the seventieth A electrode 815p in the circumferential direction, expressed as a central angle formed by the endpoints of each electrode at the axis of rotation X, is 22.5°. The angular width corresponds to one quarter of the wavelength of ultrasonic oscillation generated by the elastic member 16. In other words, the angular width of each of the sixty-first A electrode 801p, the sixty-third A electrode 803p, the sixty-eighth A electrode 813p, and the seventieth A electrode 815p is one quarter of the wavelength of the stationary wave. The angular width of each of the other A and B electrodes is 45°. The angular width corresponds to one half of the wavelength of ultrasonic oscillation generated by the elastic member 16. In other words, the angular width of each of the other A and B electrodes is one half of the wavelength of the stationary wave.

From the perspective of the axis of rotation X in the radial direction, the sixty-first A electrode 801p overlaps with the sixty-sixth A electrode 811p, the sixty-third A electrode 803p overlaps with the sixty-sixth B electrode 812m, the sixty-eighth A electrode 813p overlaps with the sixty-fourth A electrode 804p, and the seventieth A electrode 815p overlaps with the sixty-fourth B electrode 804m.

From the perspective of the axis of rotation X in the radial direction, the A and B electrodes of the exterior electrode overlap with the A and B electrodes of the interior electrode by a central angle of 22.5°. The radial borderlines between the outer electrodes are shifted 22.5° in the circumferential direction from the radial borderlines between the inner electrodes. The shifted angle corresponds to one quarter of the wavelength of the stationary wave. Note that, the radial borderline between the sixty-sixth A electrodes 811p and the seventieth A electrodes 815p corresponds to the radial borderline between the sixty-first A electrodes 801p and the sixty-fourth B electrodes 804m in the radial direction. The radial borderline between the sixty-sixth B electrodes 812m and the sixty-eighth A electrodes 813p corresponds to the radial borderline between the sixty-third A electrodes 803p and the sixty-fourth A electrodes 804p in the radial direction.

The borderline between the exterior electrode and the interior electrode is positioned closer to the outer edge than to the inner edged of the applying electrode plate 20 such that the area of each of the interior and exterior electrodes is the same, i.e., in the radial direction the borderline is the centerline that bisects the applying electrode plate 20 in the radial direction.

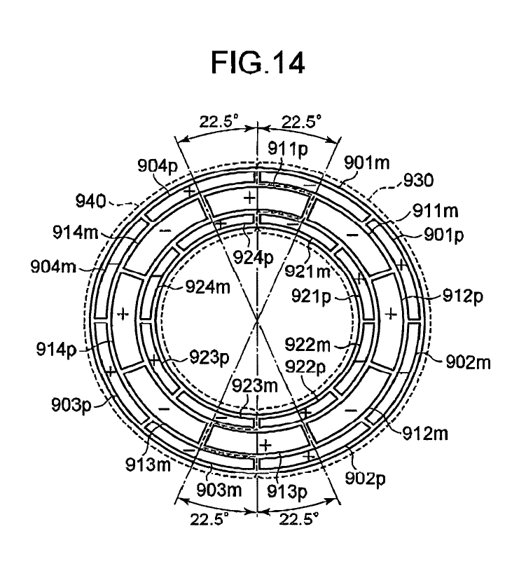

The seventh embodiment of an ultrasonic motor 10 is described below with reference to FIG. 14. The similar constructions to the first to sixth embodiments are numbered similarly, and the descriptions concerning such constructions have been omitted.

The applying electrode plate 20 comprises seventy-first to seventy-fourth A electrodes 901p-904p, seventy-fifth to seventy-eighth A electrodes 911p-914p, seventy-ninth to eighty-second A electrodes 921p-924p, seventy-first to seventy-fourth B electrodes 901m-904m, seventy-fifth to seventy-eighth B electrodes 911m-914m, and seventy-ninth to eighty-second B electrodes 921m-924m.

The seventy-first, seventy-second, seventy-sixth, seventy-seventh, seventy-ninth, and eightieth A electrodes 901p, 902p, 912p, 913p, 921p, and 922p, and the seventy-first, seventy-second, seventy-fifth, seventy-sixth, seventy-ninth, and eightieth B electrodes 901m, 902m, 911m, 912m, 921m, and 922m form a first oscillating member 930.

The seventy-third, seventy-fourth, seventy-fifth, seventy-eighth, eighty-first, and eighty-second electrodes 903p, 904p, 911p, 914p, 923p, and 924p, and the seventy-third, seventy-fourth, seventy-seventh, seventy-eighth, eighty-first, and eighty-second B electrodes 903m, 904m, 913m, 914m, 923m, and 924m form a second oscillating member 940.

The seventy-first to seventy-fourth A electrodes 901p-904p and the seventy-first to seventy-fourth B electrodes 901m-904m form an exterior electrode, and are provided on the outermost side of the applying electrode plate 20. The seventy-ninth to eighty-second A electrodes 921p-924p and seventy-ninth to eighty-second B electrodes 921m-924m form an interior electrode, and are provided on the innermost side of the applying electrode plate 20. The seventy-fifth to seventy-eighth A electrodes 911p-914p and the seventy-fifth to seventy-eighth B electrodes 911m-914m form a middle electrode, and are provided between the exterior electrode and the interior electrode. The angular width, i.e. the length of the each electrode in the circumferential direction, expressed as the central angle formed by the endpoints of each electrode at the center of the axis of rotation X, is 45°. The angular width corresponds to one half of the wavelength of ultrasonic oscillation generated by the elastic member 16. In other words, the angular width of each of the A and B electrodes is one half of the wavelength of the stationary wave described hereinbefore.

From the perspective of the engaging board 12, the seventy-first B electrode 901m, the seventy-first A electrode 901p, the seventy-second B electrode 902m, the seventy-second A electrode 902p, the seventy-third B electrode 903m, the seventy-third A electrode 903p, the seventy-fourth B electrode 904m, and the seventy-fourth A electrode 904p are aligned in that order on the applying electrode plate 20 in the clockwise direction.

Also from the perspective of the engaging board 12, the seventy-ninth B electrode 921m, the seventy-ninth A electrode 921p, the eightieth B electrode 922m, the eightieth A electrode 922p, the eighty-first B electrode 923m, the eighty-first A electrode 923p, the eighty second B electrode 924m, and the eighty-second A electrode 924p are aligned in that order on the applying electrode plate 20 in the clockwise direction.

And with respect to the middle electrode from the perspective of the engaging board 12, the seventy-fifth A electrode 911p, the seventy-fifth B electrode 911m, the seventy-sixth A electrode 912p, the seventy-sixth B electrode 912m, the seventy-seventh A electrode 913p, the seventy-seventh B electrode 913m, the seventy-eighth A electrode 914p, and the seventy-eighth B electrode 914m are aligned in that order on the applying plate 20 in the clockwise direction.

From the perspective of the axis of rotation X in the radial direction, the radial borderlines that separate the individual electrodes of the exterior electrode in the circumferential direction correspond to the radial borderlines that separate the individual electrodes of the interior electrode in the circumferential direction.

From the perspective of the axis of rotation X in the radial direction, the seventy-fifth A electrode 911p overlaps with each of the seventy-first B electrode 901m and the seventy-fourth A electrode 904p by a central angle of 22.5°, respectively. The radial borderlines between the electrodes provided on the exterior are shifted 22.5° from the radial borderlines between the electrodes provided in the middle. The shifted angle corresponds to one quarter of the wavelength of the stationary wave.

Also from the perspective of the axis of rotation X in the radial direction, the seventy-fifth A electrode 911p overlaps with each of the seventy-ninth B electrode 921m and the eighty-second A electrode 924p by the central angle of 22.5°, respectively. The radial borderlines between the electrodes provided on the interior are shifted 22.5° from the radial borderlines between the electrodes provided in the middle of the applying electrode plate 20. The shifted angle corresponds to one quarter of the wavelength of the stationary wave.

From the perspective of the axis of rotation X in the radial direction, the seventy-seventh A electrode 913p overlaps with each of the seventy-third B electrode 903m and the seventy-seventh A electrode 913p by a central angle of 22.5°, respectively. The radial borderlines between the electrodes provided on the exterior are shifted 22.5° from the radial borderlines between the electrodes provided in the middle. The shifted angle corresponds to one quarter of the wavelength of the stationary wave.

Also from the perspective of the axis of rotation X in the radial direction, the seventy-seventh A electrode 913p overlaps with each of the eighty-first B electrode 923m and the eightieth A electrode 922p by the central angle of 22.5°, respectively. The radial borderlines between the electrodes provided on the interior are shifted 22.5° from the radial borderlines between the electrodes provided in the middle of the applying electrode plate 20. The shifted angle corresponds to one quarter of the wavelength of the stationary wave.

The circumferential borderlines separating the exterior, middle and interior electrodes from one another are positioned relatively closer to the outer edge than to the inner edge of the applying electrode plate 20 such that the areas of the exterior, middle and interior electrodes are all equal, i.e., the two circumferential borderlines trisect the applying electrode plate 20 in the radial direction.

In the case that the feedback electrode 105 is omitted and the A and B electrodes are provided in the vacant space, it may become impossible to generate the turning force in the rotor 14 because the reflected wave may be generated. However, in either embodiment, each computational simulation result indicates that it is possible to generate the turning force in the rotor 14 and avoid interference caused by the reflected wave.

Note that, in either embodiment, the number of the teeth is not limited to twenty-four. Any arbitrary value can be adopted for the number of teeth according to the required performance of the ultrasonic motor 10.

The four wavelengths may not be provided on the applying electrode plate. The number of wavelengths may be an integer number greater or equal to 2. In this case, the angular width of the A and B electrodes are adjusted according to the number of wavelengths.

The applied AC voltage and the frequency may not be limited to 400V and 60 kHz.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2009-002938 (filed on Jan. 8, 2009), which is expressly incorporated herein, by reference, in its entirety.

1. An ultrasonic motor comprising:
a first oscillating member that vibrates with a given wavelength; and
a second oscillating member that is separately provided to said first oscillating member, and vibrates with the given wavelength;
an annulus being formed by said first oscillating member and said second oscillating member, and part of said first oscillating member overlapping with part of said second oscillating member in a radial direction of the annulus for one quarter of the given wavelength in a circumferential direction of the annulus.

2. The ultrasonic motor according to claim 1, wherein said first oscillating member and said second oscillating member have positive oscillating parts and negative oscillating parts that have a length of one half of the given wavelength in a circumferential direction of the annulus, and the positive oscillating parts and the negative oscillating parts are provided on an alternating basis in a circumferential direction of the annulus.

3. The ultrasonic motor according to claim 2, wherein said first oscillating member and said second oscillating member have positive oscillating parts and negative oscillating parts that have a length of three-eighths of the given wavelength in a circumferential direction of the annulus.

4. The ultrasonic motor according to claim 2, wherein the positive oscillating part of said first oscillating member overlaps with the negative oscillating part of said second oscillating member in a radial direction of the annulus for a quarter of the given wavelength in a circumferential direction of the annulus.

5. The ultrasonic motor according to claim 4, wherein the area of the overlapped positive oscillating part is substantially equal to the area of the overlapped negative oscillating part.

6. The ultrasonic motor according to claim 1, wherein the width of said first oscillating member in the radial direction is substantially equal to the width of said second oscillating member in the radial direction.

7. The ultrasonic motor according to claim 2, wherein the positive oscillating parts and the negative oscillating parts are provided twofold in the radial direction of the annulus.

8. The ultrasonic motor according to claim 2, wherein the positive oscillating parts and the negative oscillating parts are provided threefold in the radial direction of the annulus.

9. An ultrasonic motor comprising:
an elastic member that creates a travelling wave;
a rotor that rotates by the traveling wave;
a first oscillating member that vibrates said elastic member at a given wavelength; and
a second oscillating member that is separately provided to said first oscillating member, and vibrates said elastic member at the given wavelength;
an annulus being formed by said first oscillating member and said second oscillating member, part of said first oscillating member overlapping with part of said second oscillating member in a radial direction of the annulus for one quarter of the given wavelength in a circumferential direction of the annulus, and the travelling wave is created by combining the vibration created by said first and second oscillating member.

10. The ultrasonic motor according to claim 9, wherein said first oscillating member and said second oscillating member have positive oscillating parts and negative oscillating parts that have a length of one half of the given wavelength in a circumferential direction of the annulus, and the positive oscillating parts and the negative oscillating parts are provided on an alternating basis in a circumferential direction of the annulus.

11. The ultrasonic motor according to claim 10, wherein said first oscillating member and said second oscillating member have positive oscillating parts and negative oscillating parts that have a length of three-eighths of the given wavelength in a circumferential direction of the annulus.

12. The ultrasonic motor according to claim 10, wherein the positive oscillating part of said first oscillating member overlaps with the negative oscillating part of said second oscillating member in a radial direction of the annulus for a quarter of the given wavelength in a circumferential direction of the annulus.

13. The ultrasonic motor according to claim 12, wherein the area of the overlapped positive oscillating part is substantially equal to the area of the overlapped negative oscillating part.

14. The ultrasonic motor according to claim 9, wherein the width of said first oscillating member in the radial direction is substantially equal to the width of said second oscillating member in the radial direction.

15. The ultrasonic motor according to claim 10, wherein the positive oscillating parts and the negative oscillating parts are provided twofold in the radial direction of the annulus.

16. The ultrasonic motor according to claim 10, wherein the positive oscillating parts and the negative oscillating parts are provided threefold in the radial direction of the annulus.
